(19) United States
(12) Patent Application Publication
(10) Pub. No.: US 2019/0112538 A1
(43) Pub. Date: Apr. 18, 2019

(54) COMPOSITION AND USE THEREOF FOR THE REMOVAL OF ACID GASES FROM HYDROCARBON FLUID STREAMS

(71) Applicant: Dow Global Technologies LLC, Midland, MI (US)

(72) Inventor: Christophe Laroche, Lake Jackson, TX (US)

(21) Appl. No.: 16/090,952

(22) PCT Filed: Mar. 16, 2017
(86) PCT No.: PCT/US2017/022630

§ 371 Date: Oct. 3, 2018

Related U.S. Application Data
(60) Provisional application No. 62/321,468, filed on Apr. 12, 2016.

(51) Int. Cl. C10L 3/10; B01D 53/14

(52) U.S. Cl. CPC C10L 3/102; B01D 53/1493; C10L 2290/541; B01D 2252/2026; B01D 2252/205; B01D 2252/20478; B01D 2257/408; B01D 2256/24; B01D 2257/302; B01D 2257/304; B01D 2257/504; B01D 2257/308; B01D 2252/20447

(57) ABSTRACT

Disclosed is a solvent composition and use thereof for removal of one or more acid gas from a fluid stream comprising: i) a physical solvent, ii) an alkali metal organoborate, where R₃ and R₄ may be the same or different and are independently an alkylene group comprising 2 to 6 carbons, R₅ and R₆ may be the same or different and are independently H or a linear or branched alkyl group comprising from 1 to 18 carbons, and Z is an alkali metal ion; and iii) optionally an amine compound.

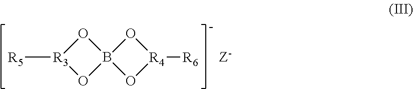

### FIELD OF THE INVENTION

The present invention relates to a solvent composition and use thereof to remove one or more acid gas form a fluid stream. Said solvent composition comprises a physical solvent, an alkyl metal organoborate, and optionally an amine compound.

### BACKGROUND OF THE INVENTION

Fluid streams derived from natural gas reservoirs, petroleum or coal, often contain a significant amount of acid gases, for example carbon dioxide (CO₂), hydrogen sulfide (H₂S), sulfur dioxide (SO₂), carbon disulfide (CS₂), hydrogen cyanide (HCN), carbonyl sulfide (COS), or mercaptans as impurities. Said fluid streams may be gas, liquid, or mixtures thereof, for example gases such as natural gas, refinery gas, hydrocarbon gasses from shale pyrolysis, synthesis gas, and the like or liquids such as liquefied petroleum gas (LPG) and natural gas liquids (NGL).

Various compositions and processes for removal of acid gas contaminants are known and described in the literature.

Acid gas removal from gas streams, particularly removal of hydrogen sulfide and carbon dioxide from gas streams formed in refinery process units, synthesis gas production plants and oil and gas production facilities, is necessary to allow this gas to be used and/or sold into pipeline systems. The removal of sulfur compounds from these acid gasses or “sour gasses” is called “sweetening.”

Typically, acid gases are removed using a solvent to remove the acid gas via the production of a rich solvent. For example, it is well-known to treat such fluid streams with chemical solvents, such as amine solutions, which rely on a chemical reaction between the solvent and acid gas contaminants The amine usually contacts the acidic gas contaminants in the fluid stream as an aqueous solution containing the amine in an absorber tower with the aqueous amine solution contacting the fluid stream counter currently. The regeneration of chemical solvents is achieved by the application of heat.

Alternatively, fluid streams may be treated with physical solvents, such as refrigerated methanol, dialkyl ethers of polyethylene glycols (DEPG), N-methyl-2-pyrrolidones (NMP), propylene carbonate, and the like which do not react chemically with the acid gas impurities. Physical solvents dissolve (absorb) the acid gas contaminants from the fluid stream, typically under high pressure. Since no chemical reactions are involved, physical solvent processes usually require less energy than chemical solvent processes. While the regeneration of chemical solvents is achieved by the application of heat, physical solvents can be stripped of impurities by reducing the pressure without the application of heat.

Acid gas contaminants are removed by contacting the contaminated product gas with fresh solvent in an absorber or other specialized equipment operated under conditions of high pressure and/or low temperature which are favorable for the type of solvent used. Once the contaminants are removed, the decontaminated gas is ready for sale, for use, or for additional downstream conditioning, depending on the product stream specifications. The solvent is regenerated for reuse by driving off the absorbed contaminants under low pressure and/or high temperature conditions favorable for desorption. Flash tanks and/or stripper columns are typically used to effect this separation.

Physical solvents tend to be favored over chemical solvents when the concentration of acid gases or other impurities is very high. Unlike chemical solvents, physical solvents are generally non-corrosive, requiring only carbon steel construction. However, over time, physical solvents may suffer from acidic degradation. Even low levels of acidic species may decrease the pH of the physical solvent to a point where corrosion of the process equipment may become a concern.

While numerous compositions for acid gas absorption and regeneration are known in the art, many suffer from one or more disadvantage or inefficiency, in particular stability to degradation. There is an ever-existing desire to further improve solvents, e.g., in respect of improved stability to reduce the potential for corrosion of process equipment.

### SUMMARY OF THE INVENTION

An object of the present invention is a solvent composition and method of use to remove of one or more acid gas from a fluid stream.

In one embodiment of the present invention, the solvent composition comprises:
i) a physical solvent, preferably a dimethyl ether of polyethylene glycol (DMPEG), propylene carbonate (PC), N-methyl-2-pyrrolidone (NMP), methanol (MeOH), blends of N-acetylmorpholine and N-formylmorpholine, 1,3-dimethyl-3,4,5,6-tetrahydro-2(1H)-pyrimidinone (DMTP), methoxytriglycol (MTG), or blends thereof, more preferably the physical solvent is one or more dimethyl ether of polyethylene glycol having the formula:

CH₃(OC₂H₄)ₙOCH₃ (II)

wherein n is from 2 to 9; ii) an alkali metal organoborate having the following formula:

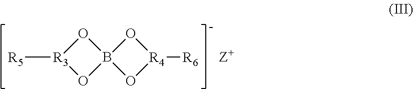

where R₃ and R₄ may be the same or different and are independently an alkylene group comprising 2 to 6 carbons, R₅ and R₆ may be the same or different and are independently H or a linear or branched alkyl group comprising from 1 to 18 carbons, and Z is an alkali metal ion, preferably sodium ethylene glycol borate, potassium ethylene glycol borate, sodium diethylene glycol borate, potassium diethylene glycol borate, sodium 1,2-propanediol borate, potassium 1,2-propanediol borate, sodium 2,3-butanediol borate, potassium 2,3-butanediol borate, sodium 1,4-butanediol borate, potassium 1,4-butanediol borate, sodium 1,2-hexanediol borate, potassium 1,2-hexanediol borate, sodium triethylene glycol borate, or mixtures thereof; and optionally iii) an amino compound, preferably selected from monoethanolamine, methylethanolamine, monoisopropanolamine, diisopropanolamine, 2-hydroxyethylpiperazine, piperazine, 1-methylpiperazine, 2-methylpiperazine, 2-(2-aminoethoxy) ethanol; 2-(2-tertiarybutylamino)propoxyethanol, 2-(2-tertiarybutylamino)ethoxyethanol, 2-(2-isopropylamino)propoxyethanol, tertiaryamylaminoethoxyethanol, (1-methyl-2-ethylpropylamino)ethoxyethanol; tris(2-hydroxyethyl)amine (triethanolamine, TEA); tris(2-hydroxypropyl)amine (triisopropanol); tributanolamine; bis(2-hydroxyethyl)methylamine (methyldiethanolamine, MDEA); 2-diethylaminoethanol (diethylethanolamine, DEEA); 2-dimethylaminoethanol (dimethylethanolamine, DMEA); 3-dimethylamino-1-propanol; 3-diethylamino-1-propanol; 2-diisopropylaminoethanol (DIEA); N,N′-bis(2-hydroxypropyl)methylamine (methyldiisopropanolamine, MDIPA); N,N′-bis(2-hydroxyethyl)piperazine (dihydroxyethylpiperazine, DiHEP)); diethanolamine (DEA); 2-(tert-butylamino)ethanol; 2-(tert-butylaminoethoxy)ethanol; 1-amino-2-methylpropan-2-ol; 2-amino-2-methyl-1-propanol (AMP), 2-(2-aminoethoxy)ethanol, or blends thereof.

Another embodiment of the present invention is a method of treating a fluid stream, preferably natural gas, refinery gas, hydrocarbon gasses from shale pyrolysis, synthesis gas, liquefied petroleum gas (LPG), natural gas liquids (NGL), or a mixture thereof comprising one or more acid gas said method comprising the step of: a) treating said fluid stream with the solvent composition disclosed herein above to form a rich solvent composition comprising one or more acid gas.

Another embodiment of the method of the present invention further comprises the step of: b) regenerating the rich solvent composition by increased temperature, decreased pressure, or a combination of both to form a lean solvent composition.

### BRIEF DESCRIPTION OF THE DRAWINGS

FIG. 1 is a titration curve for a solvent composition not of the present invention.

FIG. 2 is a titration curve for solvent composition of the present invention.

### DETAILED DESCRIPTION OF THE INVENTION

One aspect of the present invention concerns a solvent composition and method of use thereof for removal of acid gases from a fluid stream.

Fluid streams treatable by the process of the present invention may be a gas, a liquid, or mixtures thereof, for example gases produced by a gassifier comprising hydrogen, carbon dioxide, and carbon monoxide; a syngas stream comprising hydrogen, carbon dioxide, and carbon monoxide; natural gas; refinery gas; hydrocarbon gasses from shale pyrolysis; synthesis gas; and liquids such as liquefied petroleum gas (LPG) and natural gas liquids (NGL). For example, fluid streams derived from natural gas reservoirs, petroleum, or coal, comprise methane (CH₃) and commonly exist in mixtures with other hydrocarbons, principally ethane (C₂H₆), propane (C₃H₈), butanes (C₄H₁₀), pentanes (C₅H₁₂), and to a lesser extent, heavier hydrocarbons. Such fluid streams comprise a variety of impurities such as hydrogen (H₂), water (H₂O), carbon monoxide (CO), nitrogen (N₂), and acid gasses, for example carbon dioxide (CO₂), hydrogen sulfide (H₂S), sulfur dioxide (SO₂), carbon disulfide (CS₂), ammonia (NH₃), hydrogen cyanide (HCN), carbonyl sulfide (COS), and/or mercaptans. In one embodiment, the term “contaminant” refers generally to one or more of C₂ or heavier hydrocarbons, impurities, acid gasses, and mixtures thereof to be removed from a fluid stream.

Suitable solvent compositions useful in the process of the present invention may remove one or more of the above listed contaminants from the fluid stream. Solvent compositions may be non-selective, i.e., remove one or more heavier hydrocarbon/impurity/acid gas or selective, i.e., they may target specific heavier hydrocarbons/impurities/acid gas(es).

Preferred solvent compositions comprise a physical solvents, for example a polyalkylene glycol alkyl ether, propylene carbonate (PC), N-methyl-2-pyrrolidone (NMP), methanol (MeOH), blends of N-acetylmorpholine and N-formylmorpholine, 1,3-dimethyl-3,4,5,6-tetrahydro-2(1H)-pyrimidinone (DMTP), methoxytriglycol (MTG), and blends thereof.

Suitable polyalkylene glycol alkyl ethers for use in the present invention are represented by the following formula:

R₁O-(Alk-O)ₙ—R₂ (I)

wherein R₁ is an alkyl group having from 1 to 6 carbon atoms; R₂ is hydrogen or an alkyl group having from 1 to 4 carbon atoms; Alk is an alkylene group, branched or unbranched, having from 2 to 4 carbon atoms, and n is from 1 to 10.

Polyalkylene alkyl ethers of formula (I) suitable in the practice of the present invention are well known and include, without any limitation, diethylene glycol dimethyl ether, diethylene glycol diisopropyl ether, triethylene glycol dimethyl ether, triethylene glycol diisopropyl ether, tetraethylene glycol dimethyl ether, tetraethylene glycol diisopropyl ether, pentaethylene glycol dimethyl ether, pentaethylene glycol diisopropyl ether, hexaethylene glycol dimethyl ether, hexaethylene glycol diisopropyl ether, heptaethylene glycol dimethyl ether, octaethylene glycol dimethyl ether, nonaethylene glycol dimethyl ether, decaethylene glycol dimethyl ether, and any mixture thereof.

Preferred polyethylene glycol alkyl ether is a mixture consisting of dimethyl ethers of polyethylene glycols (DMPEG) of formula:

CH₃(OC₂H₄)ₙOCH₃

wherein n is from 2 to 10.

Particularly preferred polyethylene glycol alkyl ether is the mixture of dimethyl ethers of polyethylene glycols sold under the trademark SELEXOL™ from The Dow Chemical Company. SELEXOL solvent is a mixture of dimethyl ethers of polyethylene glycols comprising from 0 to 0.5 wt percent of diethylene glycol dimethyl ether, from 5 to 7 wt percent of triethylene glycol dimethyl ether, from 16 to 18 wt percent tetraethylene glycol dimethyl ether, from 23 to 25 wt percent of pentaethylene glycol dimethyl ether, from 22 to 24 wt percent of hexaethylene glycol dimethyl ether, from 15 to 17 wt percent of heptaethylene glycol dimethyl ether, from 8 to 10 wt percent of octaethylene glycol dimethyl ether, from 3 to 5 wt percent of nonaethylene glycol dimethyl ether, and from 1 to 2 wt percent of decaethylene glycol dimethyl ether. SELEXOL solvent is widely used in gas treating applications for the removal of acidic gases.

DMPEG is a mixture of dimethyl ethers of polyethylene glycol formula (II) used in what is referred to as the SELEXOL process to physically absorb H₂S, CO₂, and mercaptans from gas streams, for example see U.S. Pat. No. 6,203,599 which is incorporated herein in its entirety. Solvents containing DMPEG are licensed and/or manufactured by several companies including Coastal Chemical Company (as COASTAL™ AGR) and Dow (SELEXOL). Other process suppliers such as Clariant GmbH of Germany offer similar solvents. Clariant solvents are a family of dialkyl ethers of polyethylene glycol under the GENOSORB™. DMPEG can be used for selective H₂S removal which requires stripping, vacuum stripping, or a reboiler.

The physical solvent is present in the solvent composition in an amount of equal to or greater than 90 weight percent, preferably in an amount of equal to or greater than 92.5 weight percent, and more preferably in an amount of equal to or greater than 95 weight percent based on the total weight of the solvent composition. The physical solvent is present in the solvent composition in an amount of equal to or less than 99.5 weight percent, preferably in an amount of equal to or less than 99 weight percent, and more preferably in an amount of equal to or less than 98 weight percent based on the total weight of the solvent composition.

The solvent composition of the present invention comprises a buffering agent. Suitable buffering agents are alkyl metal organoborates selected from the group consisting of the condensation products of an alkyl metal borate and a glycol having the formula:

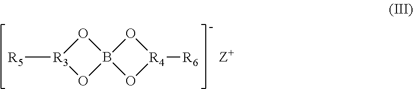

where R₃ and R₄ may be the same or different and are independently an alkylene group comprising 2 to 6 carbons, R₅ and R₆ may be the same or different and are independently H, or a linear or a branched alkyl group comprising from 1 to 18 carbons, preferably from 1 to 8 carbons, and Z is an alkali metal ion, preferably lithium, sodium, potassium, cesium, or ammonium salts.

Preferably, the alkyl metal organoborate selected from the group consisting of the condensation products of an alkyl metal borate and a (substituted) 1,2-ethylene glycol having the formula:

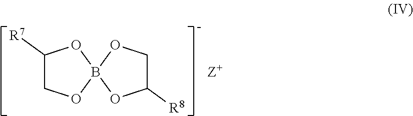

where R₇ and R₈ may be the same or different and are H, or a linear or a branched alkyl group having 1 to 18 carbons, preferably H or a linear or a branched alkyl group having 1 to 10 carbons, more preferably H or a linear or a branched alkyl group having 1 to 6 carbons and Z is an alkali metal ion, preferably lithium, sodium, potassium, cesium or ammonium salts.

Preferably the alkyl metal organoborate is the condensation product of an alkyl metal borate and a material selected from the group consisting of ethylene glycol, diethylene glycol, triethylene glycol, 1,4-butanediol, 2,3-butanediol, and 1,2-propanediol, said glycol borate condensation products consisting essentially of a mole ratio of from 6:1 to 20:1 of diol to equivalent alkyl metal tetra borate.

Preferred alkyl metal organoborates are sodium ethylene glycol borate, potassium ethylene glycol borate, sodium diethylene glycol borate, potassium diethylene glycol borate, sodium 1,2-propanediol borate, potassium 1,2-propanediol borate, sodium 2,3-butanediol borate, potassium 2,3-butanediol borate, sodium 1,4-butanediol borate, potassium 1,4-butanediol borate, sodium 1,2-hexanediol borate, potassium 1,2-hexanediol borate, sodium triethylene glycol borate, or mixtures thereof.

The alkyl metal organoborate is present in the solvent composition in an amount of equal to or greater than 0.25 weight percent, preferably in an amount of equal to or greater than 0.5 weight percent, and more preferably in an amount of equal to or greater than 1 weight percent based on the total weight of the solvent composition. The alkyl metal organoborate is present in the solvent composition in an amount of equal to or less than 10 weight percent, preferably in an amount of equal to or less than 7.5 weight percent, and more preferably in an amount of equal to or less than 5 weight percent based on the total weight of the solvent composition.

The solvent composition of the present invention may further comprise an amino compound. Suitable amino compounds include, but are not limited to, monoethanolamine, methylethanolamine, monoisopropanolamine, diisopropanolamine, 2-hydroxyethylpiperazine, piperazine, 1-methylpiperazine, 2-methylpiperazine, 2-(2-aminoethoxy) ethanol; 2-(2-tertiarybutylamino)propoxyethanol, 2-(2-tertiarybutylamino)ethoxyethanol, 2-(2-isopropylamino)propoxyethanol, tertiaryamylaminoethoxyethanol, (1-methyl-2-ethylpropylamino)ethoxyethanol; tris(2-hydroxyethyl)amine (triethanolamine, TEA); tris(2-hydroxypropyl)amine (triisopropanol); tributanolamine; bis(2-hydroxyethyl)methylamine (methyldiethanolamine, MDEA); 2-diethylaminoethanol (diethylethanolamine, DEEA); 2-dimethylaminoethanol (dimethylethanolamine, DMEA); 3-dimethylamino-1-propanol; 3-diethylamino-1-propanol; 2-diisopropylaminoethanol (DIEA); N,N′-bis(2-hydroxypropyl)methylamine (methyldiisopropanolamine, MDIPA); N,N′-bis(2-hydroxyethyl)piperazine (dihydroxyethylpiperazine, DiHEP)); diethanolamine (DEA); 2-(tert-butylamino)ethanol; 2-(tert-butylaminoethoxy)ethanol; 1-amino-2-methylpropan-2-ol; 2-amino-2-methyl-1-propanol (AMP), 2-(2-aminoethoxy)ethanol, and blends thereof.

Suitable amino compounds may be selected from a primary amine, a secondary amine, a tertiary amine, or blends thereof.

If present, the amino compound is present in the solvent composition in an amount of equal to or greater than 0.25 weight percent, preferably in an amount of equal to or greater than 0.5 weight percent, and more preferably in an amount of equal to or greater than 1 weight percent based on the total weight of the solvent composition. If present, the amino compound is present in the solvent composition in an amount of equal to or less than 10 weight percent, preferably in an amount of equal to or less than 7.5 weight percent, and more preferably in an amount of equal to or less than 5 weight percent based on the total weight of the solvent composition.

The solvent composition of the present invention may further comprise an additional additive selected from a low temperature viscosity improver, a corrosion inhibitor, an antifoaming agent, or mixtures thereof in an amount of 0.1 to 10 weight percent wherein weight percents are based on the total weight of the composition.

A physical solvent acid gas removal process is based on the solubility of the acid gases, for example CO₂, H₂S, SO₂, CS₂, COS, HCN, NH₃, mercaptans and the like, within the solvent, instead of on chemical reactions between the acid gas and the solvent. Solubility depends primarily on partial pressure and secondarily on temperature. Higher acid-gas partial pressures and lower temperatures increase the solubility of H₂S, CO₂, etc. in the solvent and thus decrease the acid-gas components. Various organic solvents are used to absorb the acid gases. Regeneration of the solvent is accomplished by flashing to lower pressures and/or stripping with solvent vapor or a condensable stripping gas, such as steam. Some solvents can be regenerated by flashing only and require no heat. Other solvents require stripping and heat.

The simplest version of a physical solvent process involves absorption followed by regeneration of the solvent by flashing to atmospheric pressure or vacuum, or by inert gas stripping. If H₂S is present at only very low concentrations or is entirely absent, this flow scheme is usually applicable since CO₂ concentrations as high as 2 or 3 percent can often be tolerated in the product gas. When H₂S is present in significant amounts, thermal regeneration is usually necessary to accomplish the thorough stripping of the solvent needed to reach stringent H₂S purity requirements. Some physical solvents, such as propylene carbonate, cannot be thermally regenerated since they are unstable at the high temperature required to completely strip H₂S from the rich solvent. Heat requirements are usually much less for physical solvents than for chemical solvents such as amines since the heat of desorption of the acid gas for the physical solvent is only a fraction of that for chemical solvents. The circulation rate of the physical solvent may also be less, particularly when the acid gas partial pressure is high.

### EXAMPLES

### Preparation of Alkyl Metal Organoborate Compounds:

In a 25 mL glass vial equipped with a septa cap is added the diol (16 or 18 g) followed by the tetraborate salt (2 or 4 g) (sodium or potassium tetraborate pentahydrate, respectively CAS # 12179-04-3 and CAS # 12045-78-2). The solutions are placed into a sonicator at 60° C. and sonicated for 2 hours or until the tetraborate salt is dissolved. The reactants for Examples 1 to 8 are shown in Table 1.

TABLE 1

| | | | Tetraborate Salt |
|---|---|---|---|
| Example | Diol | Alkyl metal | Concentration |
| 1 | Ethylene Glycol | Na | 10 |
| 2 | Ethylene Glycol | Na | 20 |
| 3 | Ethylene Glycol | K | 20 |
| 4 | Propylene Glycol | Na | 10 |
| 5 | Propylene Glycol | Na | 20 |
| 6 | Propylene Glycol | K | 20 |
| 7 | 1,2-Butanediol | Na | 10 |
| 8 | 1,2-Hexanediol | Na | 10 |

### Solubility of Alkyl Metal Organoborates in a Physical Solvent at Various Concentrations:

In a 25 mL glass vial equipped with a septa cap is added SELEXOL (19.5 or 19 g) (CAS # 24991-55-7) available from The Dow Chemical Company, followed by the alkyl metal organoborate (0.5 or 1 g). The solutions are agitated/shaken and checked for appearances. Typically insolubility of the complex leads to a turbid solution. The results are provided in Table 2.

TABLE 2

| Example | Concentration, wt % | Turbidity |
|---|---|---|
| 1 | 5 | no |
| 2 | 2.5 | yes |
| 3 | 2.5 | yes |
| 4 | 5 | no |
| 5 | 2.5 | no |
| 6 | 2.5 | no |
| 7 | 5 | yes |
| 8 | 5 | yes |

Reserve alkalinity of SELEXOL Solvent versus buffered SELEXOL Solvent with Example 3:

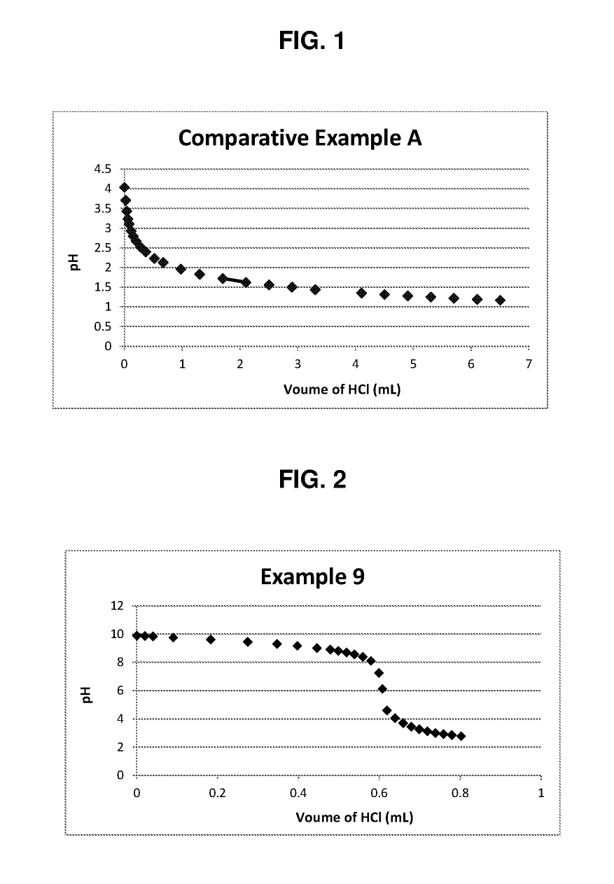

A SELEXOL Solvent solution (Comparative Example A) and a pH buffered SELEXOL Solvent solution containing 2.5 wt % of Example 6 (Example 9) are titrated using 0.5N HCl and an automatic titrator Mettler Toledo T90. The titration is performed using hydrochloric acid (HCl) purchased from Fisher Scientific at 0.5N concentration on a 10 g sample size. The titration curves are displayed in FIG. 1 for Comparative Example A and FIG. 2 for Example 9.

What is claimed is:

1. A solvent composition for removal of one or more acid gas from a fluid stream comprising:
i) a physical solvent and
ii) an alkali metal organoborate having the following formula: 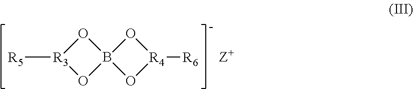
where R₃ and R₄ may be the same or different and are independently an alkylene group comprising 2 to 6 carbons,
R₅ and R₆ may be the same or different and are independently H or a linear or branched alkyl group comprising from 1 to 18 carbons, and
Z is an alkali metal ion.

2. The solvent composition of claim 1 wherein the physical solvent is a dimethyl ether of polyethylene glycol (DMPEG), propylene carbonate (PC), N-methyl-2-pyrrolidone (NMP), methanol (MeOH), blends of N-acetylmorpholine and N-formylmorpholine, 1,3-dimethyl-3,4,5,6-tetrahydro-2(1H)-pyrimidinone (DMTP), methoxytriglycol (MTG), or blends thereof.

3. The solvent composition of claim 1 wherein the physical solvent is one or more dimethyl ether of polyethylene glycol having the formula:
CH₃(OC₂H₄)ₙOCH₃
wherein n is from 2 to 9.

4. The solvent composition of claim 1 wherein the alkali metal organoborate is sodium ethylene glycol borate, potassium ethylene glycol borate, sodium diethylene glycol borate, potassium diethylene glycol borate, sodium 1,2-propanediol borate, potassium 1,2-propanediol borate, sodium 2,3-butanediol borate, potassium 2,3-butanediol borate, sodium 1,4-butanediol borate, potassium 1,4-butanediol borate, sodium 1,2-hexanediol borate, potassium 1,2-hexanediol borate, sodium triethylene glycol borate, or mixtures thereof.

5. The solvent composition of claim 1 further comprising iii) an amino compound.

6. The solvent composition of claim 5 wherein iii) the amino compound is selected from monoethanolamine, methylethanolamine, monoisopropanolamine, diisopropanolamine, 2-hydroxyethylpiperazine, piperazine, 1-methylpiperazine, 2-methylpiperazine, 2-(2-aminoethoxy) ethanol; 2-(2-tertiarybutylamino)propoxyethanol, 2-(2-tertiarybutylamino)ethoxyethanol, 2-(2-isopropylamino)propoxyethanol, tertiaryamylaminoethoxyethanol, (1-methyl-2-ethylpropylamino)ethoxyethanol; tris(2-hydroxyethyl)amine (triethanolamine, TEA); tris(2-hydroxypropyl)amine (triisopropanol); tributanolamine; bis(2-hydroxyethyl)methylamine (methyldiethanolamine, MDEA); 2-diethylaminoethanol (diethylethanolamine, DEEA); 2-dimethylaminoethanol (dimethylethanolamine, DMEA); 3-dimethylamino-1-propanol; 3-diethylamino-1-propanol; 2-diisopropylaminoethanol (DIEA); N,N′-bis(2-hydroxypropyl)methylamine (methyldiisopropanolamine, MDIPA); N,N′-bis(2-hydroxyethyl)piperazine (dihydroxyethylpiperazine, DiHEP)); diethanolamine (DEA); 2-(tert-butylamino)ethanol; 2-(tert-butylaminoethoxy)ethanol; 1-amino-2-methylpropan-2-ol; 2-amino-2-methyl-1-propanol (AMP), 2-(2-aminoethoxy)ethanol, or blends thereof.

7. A method of treating a fluid stream comprising one or more acid gas said method comprising the step of:
a) treating said fluid stream with a solvent composition comprising:
i) a physical solvent and
ii) an alkali metal organoborate having the following formula: 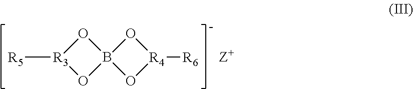
where R₃ and R₄ may be the same or different and are independently an alkylene group comprising 2 to 6 carbons,
R₅ and R₆ may be the same or different and are independently H or a linear or branched alkyl group comprising from 1 to 18 carbons, and
Z is an alkali metal ion,
to form a rich solvent composition comprising one or more acid gas.

8. The method of claim 7 wherein the fluid stream is natural gas, refinery gas, hydrocarbon gasses from shale pyrolysis, synthesis gas, liquefied petroleum gas (LPG), natural gas liquids (NGL), or a mixture thereof.

9. The method of claim 7 wherein the composition further comprises iii) an amino compound.

10. The method of claim 7 further comprising the step of:
b) regenerating the rich solvent composition by increased temperature, decreased pressure, or a combination of both to form a lean solvent composition.
